(19) United States
(12) Patent Application Publication
(10) Pub. No.: US 2026/0360171 A1
(43) Pub. Date: Nov. 12, 2026

(54) METHOD FOR THE SEMI-AUTOMATIC EXTRACTION OF SENSITIVE DATA FROM DOCUMENTS SUBJECT TO STRICT CONFIDENTIALITY OF THESE DATA

(71) Applicant: INOVATIC TECHNOLOGIES, VERSAILLES (FR)

(72) Inventor: Philippe VINCENT, VERSAILLES (FR)

(21) Appl. No.: 19/130,277

(22) PCT Filed: Nov. 14, 2023
(86) PCT No.: PCT/FR2023/051789

§ 371 Date: May 15, 2025

(30) Foreign Application Priority Data
Nov. 15, 2022 (FR) FR2211885

(51) Int. Cl. G06V 30/12; G06V 30/19; G06V 30/412

(52) U.S. Cl. CPC G06V 30/127; G06V 30/19013; G06V 30/412

(57) ABSTRACT

A method for extracting data entered in a document while preserving the confidentiality of these data includes the step of entering data into a document and sending the document to a secure kernel, where it is deformed. The method further includes using a control interface whereby an auditor is able to enter identifiers enabling the nature of the data to be determined, and verify the consistency of elementary images extracted from the data with characters resulting from the OCR processing of the data. Once these verifications have been carried out, the secure kernel associates the verified identifiers with the corrected data, enabling a verified results file to be obtained.

### CROSS-REFERENCE TO RELATED APPLICATIONS

This application is a 35 U.S.C. § 371 National Stage patent application of no. PCT/FR2023/051789, filed on 14 Nov. 2023, which claims the benefit of French patent application no. FR2211885, filed on 15 Nov. 2022, the disclosures of which are incorporated herein by reference in their entirety.

### TECHNICAL FIELD

The present disclosure relates to the field of extracting data from material (paper) or digital (computer image files) documents of the Referenced Tabular Document type, the boxes of which are filled in with printed character data.

### BACKGROUND

In many fields, it is important to be able to extract such data in an automated or semi-automated manner to feed data into subsequent processes.

For this purpose, character recognition tools, known as OCR (Optical Character Recognition), are conventionally used, making it possible to generate ASCII (American Standard Code for Information Interchange) type character strings from image files of the documents to be processed.

The data extracted from these files resulting from the OCR can then be subject to computer processing adapted to different needs.

These processing may comprise, for example, verification, calculation or evaluation operations.

An example of the above application concerns the field of finance and accounting.

In this field, Referenced Tabular Documents must be edited by companies, for example to declare their annual results, or to edit pay slips. This filling can be done by typing strokes positioned on the correct boxes of the blank Referenced Tabular Document or, more modernly, through Document-image editing software based on, in the background, the standardized template, and the relevant data extracted from the company's Databases, and provided in the relevant boxes.

These Referenced Tabular Documents are presented as listed successions of table pages made up of lines and columns where the numerical data (financial, salary or accounting) are provided by users in materialized rectangular boxes and the nature of which is indicated by alphanumeric headings at the head of the lines and columns. Each box is thus identified as the intersection of a line and a column.

Often, the Referenced Tabular Document associates with the lines, Identifiers appearing at the head of the line, to the right of the alphanumeric heading, but this is not always the case (example of pay slips, where, for the needs of the disclosure, such identifiers must be arbitrarily defined), whereas, for the columns, in practically all cases, arbitrary identifiers must be agreed upon. Sometimes, certain boxes are preceded by an individual identifier characterizing it, but this is too exceptional to base the method on these. We will therefore be led to assign to each box a box identifier composed of the line identifier concatenated with the column identifier of the box.

The subject of the disclosure is the analysis of these Referenced Tabular Documents to extract the values for the purposes of various calculations of a financial, accounting or administrative nature in order to meet specific needs (for example, calculations of Research tax credit from salary slips of the researchers).

By processing the Referenced Tabular Documents thus filled in with OCR tools, one can attempt to extract the identifier/value pairs from each filled in box, these pairs being placed in a structured results file for later use, subject to possible OCR errors, the OCR techniques never being able to guarantee the accuracy of the recognized characters, a reservation which must be lifted by the invented Method.

This exploitation can comprise, according to another example linked to the financial results, the use of the results file by the risk assessment department of a bank: the identifier/amount pairs extracted from the accounts of a company in fact make it possible to immediately and automatically reconstitute the profile of financial risk associated with this company, by applying classic calculations and ratios in the field of finance.

Depending on the obtained risk profile, the banking establishment may, for example, decide whether or not to grant a bank loan to the relevant company.

There is a strong demand, particularly from banking establishments, for the data extracted from the Referenced Tabular Documents filled in by companies to be reliable, that is to say for them to have been verified.

There are in fact a certain number of factors which can lead to the production of errors in the identifier/amount pairs extracted with the automated or semi-automated processing tools available in the state of the art.

Among these error factors are errors inherent in the use of OCR tools: for example, a digit damaged by printing in a box of the Referenced Tabular Document fed by the company can give rise to a misinterpretation by the OCR tool (this is then called “substitution”).

Another error factor is related to the variability of the Referenced Tabular Documents used by companies.

There are in fact Tabular Document Templates designed by the French Administration-designated by “CERFA” forms which we have become accustomed to using as reference documents for the financial results of Companies (“Balance Sheets”), having the advantage of existing and being standardized and managed by the State.

However, CERFA forms are Tabular Document Templates for tax purposes, not accounting purposes, and publishers of Accounting Balance Sheets are led to create “modified” versions to meet their “business” needs. They are thus led to create Referenced Tabular Documents which are mixed documents playing the dual role of Documents sent to the Tax Administration as a tax return, and of Accounting Document reflecting the financial development of the Company.

As a result, the Referenced Tabular Documents are inspired by the CERFA forms while adding additional financial information, in unregulated forms, introducing uncontrolled variability, the Tax Administration accepting these Referenced Tabular Documents as long as it finds what it requests there, but the accounting additions complicate, by their uncontrolled variability, their automatic extraction of data for the purposes of financial analyses.

These Referenced Tabular Documents, modified in relation to the Tabular Document Templates, may comprise additional comments, boxes, lines, columns. For example, in FIG. 3, a 4th column is often added to report the results of the previous year, which can be compared to those represented in the 3rd column, making it possible to measure the direction and value of the change from one year to the next. The heading of the last two columns lends itself to variable forms, such as “N”, “N−1” or “|31|12|2021|”, “|31|12|2020|”, closing dates represented in rakes and therefore subject to reading errors of digits. Other disturbances of the same order may appear on other pages or in other places (inversion of columns N and N−1, etc.). In addition, there are terminological, abbreviative and synonymous variants in the alphanumeric headings of the lines and the column titles, and sometimes additional or inverted lines.

This variability can lead in particular to the association of an incorrect identifier with an amount when processing the data resulting from the OCR.

Thus, to meet the demand for reliability of structured results files transmitted to banking establishments, companies providing verification services must use different verification methods, both for the Identifiers and for the values of the amounts contained in these boxes.

Some of these methods, which are fully automated and based in particular on artificial intelligence, make it possible to improve the reliability of data transmitted to banking establishments, without however reaching the 100% reliability level required by these establishments.

Other, semi-automated, methods make it possible to achieve a higher level of reliability.

These methods involve trustees who ensure, on appropriate interface screens, that the amounts resulting from the OCR processing of the form filled in by the company do not contain any errors, and that they are associated with the correct box identifiers.

This human verification thus makes it possible to ensure that the value of the amount and its allocation are correct.

These semi-automated methods assume by construction that the trustees have before them the associated identifiers and amounts.

From this visibility, the trustees can therefore have access to all the accounting information of a company.

However, there is a growing demand from banking authorities so that the verification operations of structured data of the identifier/amount type can be performed in a fillely confidential manner, that is to say by avoiding, as far as possible, any data leaks on the part of a malicious trustee, based on the principle that in this verification he/she is led to see this data, whereas the accounting information of a company is considered a priori as belonging to it without any organization being able to arrogate to itself the right to decide otherwise.

This growing demand stems in particular from directives issued by the EBA (European Bank Authority), which in particular leads to prohibiting EU banking establishments from subcontracting data to external data entry companies likely, as mentioned above, to cause data leaks, requiring them to internalize this verification/correction, based on the principle that this internalization allows the Bank to better control the risks of sensitive data leaks. This confidentiality obligation also applies to initial Referenced Tabular Documents which may be Salary Slips containing personal data which, since 2016, have been protected for European citizens by Confidentiality rules defined in a General Data Protection Regulation (GDPR, Regulation No. 2016/679 of the European Parliament and of the Council of Apr. 27, 2016).

In the two previous examples, the digital values to be extracted are monetary data (in € for the EU), subject to the dual imperative of rigorous accuracy and guaranteed confidentiality, incompatible with each other since accuracy can only be guaranteed through human verification, opening the way to possible data leaks.

### SUMMARY

The aim of the present disclosure is to provide a solution to this apparent contradiction through a novel entry method which circumvents the problem by combining new concepts which contradict the prejudice of such incompatibility.

The services offered by accounting and financial data entry/verification companies currently available on the market are incompatible with these confidentiality obligations, particularly regarding the intervention of trustees who have clear access to the amounts and their associated identifiers appearing in the Documents filled in by the companies.

The present disclosure relates to a method for the semi-automatic extraction of data located in a referenced tabular paper or digital document, comprising boxes, identifiers of these boxes and amounts filled in these boxes, comprising the steps of:
a. sending an image file of the filled in referenced tabular document in a secure kernel computer without a trustee having access to it,
c. removing by means of this kernel computer all the amounts filled in the boxes of the referenced tabular document, leading to a so-called “disfigured” referenced tabular document,
e. providing the correct identifiers inside the concerned boxes, emptied of their amounts,
f. causing the kernel computer to extract the images of each digit making up each of said amounts,
g. associating by means of the kernel computer the corresponding digit obtained by OCRing the filled in referenced tabular document with each of said images,
h. causing a trustee to verify on a driving interface whether the conversion of the image of the digit into an OCRed digit has been performed without error, by reading and comparing isolated digits whose origin the trustee cannot identify,
i. if this is not the case, causing the trustee to correct the erroneous value on the driving interface,
j. updating by means of the kernel computer the values associated with said images,
k. causing the kernel computer to browse through all the boxes of the referenced tabular document in which the verified identifiers were filled in in at step e) and causing the kernel computer to associate the underlying amounts reconstituted by this kernel computer with each of these identifiers.

The terms “OCRing in this kernel computer the referenced tabular document” mean OCR the image file of the filled in referenced tabular document.

The referenced tabular document may be the filled in referenced tabular document.

The disclosure may also comprise the following characteristics taken alone or in combination.

According to one characteristic, the method further comprises the following step of:
b) OCRing in this kernel computer this referenced tabular document.

According to one characteristic, the method further comprises the following step of:
d) storing these amounts in memory in the kernel computer, such that they become underlying, that is to say not accessible to the trustee.

According to one characteristic, the method comprises a step of generating the image file of the filled in referenced tabular document.

Advantageously, this allows to OCR the image file later.

According to one characteristic, said digit images are grouped by shape proximity class.

The terms “shape proximity classes” mean similarity classes in which digits or characters having a similar shape are grouped.

According to one characteristic, the method comprises a step of comparing the digit images with each other.

According to one characteristic, the comparison of the digit images is done based on the pixel composition of said digit images in order to identify similarities in the pixel compositions of the digit images.

The pixel composition of an image is the number of pixels and the arrangement of pixels within the image.

Advantageously, this makes it possible to identify digit images substantially similar in a simple manner in order to group the images corresponding to the same digit in the same group.

According to one characteristic, the method comprises a step of distributing the digit images into similarity classes based on a result of the comparison of their pixel composition, so that two images whose pixel compositions are substantially identical are comprised in the same similarity class.

The terms “similarity class” mean a collection of objects, for example images, that share a common property. For example, a class that relates to the number “8” comprises a plurality of images that show the number “8”.

The terms “substantially identical pixel compositions” mean, for example, pixel compositions which differ in the number of pixels in the composition only by a number of pixels less than 10, and preferably less than 4, and preferably less than 2.

Advantageously, this makes it possible to reduce the number of digit images to be verified by a trustee.

According to one characteristic, the shape proximity classes are determined by grouping the images that differ from each other only by a few isolated pixels. The terms “a few isolated pixels” mean for example at least 2 pixels, for example 2 pixels, 3 pixels or 4 pixels.

According to one characteristic, the method comprises a step of modifying at least one parameter of a digit image before comparing said digit image with another digit image.

The “parameter of a digit image” can be selected from: a dimension of the image such as a width or a length of the image, a number of pixels in the image, or even an arrangement of the pixels of the image.

Advantageously, this makes it possible to make the comparison between the digit images more precise.

According to one characteristic, the at least one parameter is a dimension of the digit image.

The dimension of an image in pixels is the size of the image, expressed for example in number of pixels. The pixels are the smallest elements that make up a digital image. They are disposed in lines and columns, and the dimension of an image is defined for example by the number of pixels across the width and the number of pixels across the height of the image.

Advantageously, this ensures that a digit image is properly classified in the class where it should be classified despite a difference in its pixel composition which would be due to a fortuitous variation in the size of the digit image.

According to one characteristic, the correct identifiers are filled in at step e) by a trustee.

According to one characteristic, the correct identifiers (33, 35) are pre-filled in at least in part in step e) by the kernel computer, and a trustee verifies that the identifiers pre-filled in by the kernel computer are correct.

According to one characteristic, step e) is carried out by transferring to the empty boxes of the disfigured referenced tabular document corresponding identifiers provided in the boxes of a so-called “augmented” tabular document template and freezing the choices decided for these identifiers for the considered template.

According to one characteristic, a so-called “revealing” file associated with the referenced, for example verified referenced, tabular document in accordance with any one of the preceding claims, is stored in the kernel computer, this revealing file comprising a file of physical location of the identifiers in said referenced tabular document and a file of the digits verified by the trustee, this revealing file not containing any of the amounts appearing in the boxes of the filled in referenced tabular document, and when a passage of the referenced tabular document, this passage is detected by means of the kernel computer (27) and the revealing file is loaded into the memory of the kernel computer, making it possible to regenerate identically the results verified by the trustee.

According to one characteristic, the method comprises the following step of: grouping the digit images extracted in d) into shape similarity classes by an algorithm having the property that two images grouped in the same class cannot represent two different digits.

According to one characteristic, the method comprises the following step of: using the strong coincidence algorithm as a shape proximity algorithm having the same property.

According to one characteristic, step h) comprises causing a trustee to verify (49) on a driving interface (31) whether the conversion of these images (51) in OCRed digits (53) was performed without error, by visualizing these labeled digits presented on the screen in order of their recognized values on several lines of a table, not allowing the trustee to reconstruct the original amounts.

The disclosure further relates to a method for the semi-automatic extraction of data located in a referenced tabular paper or digital document, comprising boxes, identifiers of these boxes and amounts filled in these boxes, comprising the steps of:
a. sending an image file of the filled in referenced tabular document in a secure kernel computer without a trustee having access to it,
c. removing by means of this kernel computer all the amounts filled in the boxes of the referenced tabular document, leading to a so-called “disfigured” referenced tabular document,
e. providing the correct identifiers in the relevant boxes, emptied of their amounts,
f. grouping the digit images extracted in d) into shape proximity class by an algorithm having the property that two images grouped in the same class cannot represent two different digits,
h. causing a trustee to verify on a driving interface whether the conversion of these images into OCRed digits has been performed without error, by viewing these labeled digits presented on the screen in order of their recognized values on several lines of a table, not allowing the trustee to reconstruct the original amounts,
i. if this is not the case, causing the trustee to correct the erroneous value on the driving interface,
j. updating by means of the kernel computer the values associated with said images,
k. causing the kernel computer to browse through all the boxes in the referenced tabular document in which the verified identifiers were filled in at step e) and causing the kernel computer to associate to each of these identifiers the underlying amounts reconstituted by this kernel computer.

According to one characteristic, the method may comprise one or several of the characteristics presented above, according to any of their technically possible combinations.

According to one characteristic, the method may comprise: g. associating by means of the kernel computer the corresponding digit obtained by OCRing the filled in referenced tabular document with each of said images, and/or using the strong coincidence algorithm as a shape proximity algorithm having the same property.

The disclosure further relates to a computer program including instructions for implementing the method described above when the program is executed by a processor.

The present disclosure therefore relates to a method for the semi-automatic extraction of data located in a referenced tabular, paper or digital, document comprising boxes, identifiers of these boxes and amounts filled in these boxes, comprising the steps of:
a. sending an image file of the referenced tabular document filled in a secure kernel computer without a trustee having access to it,
b. OCRing in this kernel computer the referenced tabular document,
c. removing by means of this kernel computer all the amounts filled in the boxes of the referenced tabular document, leading to a so-called “disfigured” referenced tabular document,
d. storing these amounts in memory in the kernel computer, so that they become underlying, i.e. not accessible to the trustee,
e. providing the correct identifiers in the relevant boxes, emptied of their amounts,
f. causing the kernel computer to extract the images of each digit making up each of said amounts,
g. associating by means of the kernel computer the corresponding digit obtained by OCRing the filled in referenced tabular document with each of said images,
h. causing a trustee to verify on a driving interface (31) whether the conversion of the image of the digit into an OCRed digit has been performed without error, by reading and comparing isolated digits whose origin the trustee cannot identify,
i. if this is not the case, causing the trustee to correct the erroneous value on the driving interface,
j. updating by means of the kernel computer the values associated with said images,
k. causing the kernel computer to browse through all the boxes in the referenced tabular document in which the verified identifiers were filled in in at step e) and causing the kernel computer to associate the underlying amounts reconstituted by this kernel computer with each of these identifiers.

The present disclosure thus aims in particular to provide the means for verifying the structured data extracted from filled in Referenced Tabular Documents, while respecting the confidentiality obligations described above, despite the intervention of a trustee.

The present disclosure thus relates to a method for the semi-automatic extraction of sensitive digital Data, such as financial or salary amounts in Referenced Tabular Documents, which are image files filled in with printed characters, where the identification of such Data can be ensured automatically by a kernel computer, when the recognition of this data, by an OCR incorporated in the kernel for example, requires verification by trustees in order to ensure “faultlessness” while guaranteeing Total Confidentiality, despite the fact that these trustees are likely to transgress this requirement if they see them, this method comprising the steps of:
a) creating a “disfigured” image of the Referenced Tabular Document where all sensitive amounts have been erased by the kernel, this disfigured Referenced Tabular Document being the only Document presented to the trustees, thus making any data leak impossible, but allowing them to perform their work of identifying each Data in view of their textual and structural environment, and
b) causing the kernel to automatically extract from the undisfigured image all the digits making up said data and to present their images “in separate pieces” and in scattered order to the trustees, who verify and provide their individual values without being able to reconstruct the amounts, the kernel being responsible for reconstructing said data upon receipt of these results.

According to other optional characteristics of the method according to the disclosure:
the digit images extracted from the amounts by the kernel are grouped into Digit Templates through an equivalence relation carried out by a shape proximity algorithm ensuring that two equivalent images cannot represent different digit, making it possible to reduce the recognition by OCR to a representative of each equivalence class, the kernel recomposing the amounts by extracting again the images of the digits from each box of said filled in Referenced Tabular Document, by finding for each of them to which digit Template it belongs, by comparison through the proximity algorithm, this method reducing by the same amount the verification by a human operator of the results found by the OCR, the reduction being able to be a division by at least 100, the quantitative gain becoming qualitative at this level of reduction.

In order to be able to associate, by means of the kernel computer, the corresponding digit obtained by OCRing the filled in referenced tabular document with each of said images, the kernel computer can implement a distribution of the digit images into similarity classes.

The terms “kernel computer” mean, for example, a computer that has only an operating system kernel and in which there is no application or driver installed.

In order to generate digit templates (or similarity classes) as indicated for example in step g), the generated digit images can be browsed by the kernel computer. The first image can be selected as representative of a first similarity class.

Then a second image can be compared to the first image. The terms “second image compared to the first image” mean that the pixel composition of the two images is compared, that is, the number of pixels that make up the image and the arrangement of the pixels (the pixel coordinates).

If the second image is similar to the first image, the second image can be classified in the same similarity class as the first image.

Alternatively, a second similarity class may be created, and the second image may be classified into the second similarity class and may become the image representative of that second similarity class.

For classifying a new image, the new image may be compared to the image of the first class and to the image of the second class in order to determine the class into which it may be classified. If the new image is not similar to any of the representative images of the existing classes, then a new similarity class may be created, and the new image may be classified into this new similarity class. This method for classifying according to similarity classes may continue until all the digit images are classified into similarity classes.

A particular example of implementation of the shape proximity algorithm which can be executed in step g) for example and which can carry out this classification according to similarity classes is the algorithm called “strong coincidence”. Thus, the association by means of the kernel computer of the corresponding digit obtained by OCRing the filled in referenced tabular document with each of said images amounts to classifying the digit images into similarity classes.

The strong coincidence algorithm is as follows:

Let A and B be the digit images tested by the strong coincidence algorithm.

A first step of the strong coincidence algorithm can consist of verifying whether A and B have the same dimension, for example the same width or the same height, or ever if the difference in pixel composition of the images A and B is less than a difference limit value. The terms “difference limit value”, mean that the images A and B can be considered similar if the difference in number of pixels between the images A and B is less than or equal to four pixels for example.

If this is not the case, then the output of the algorithm may be that the images A and B are not in strong coincidence, in other words the images are not substantially similar.

A second step of the strong coincidence algorithm may consist of modifying a parameter of the image A or of the image B, for example a dimension of the image A or a dimension of the image B. This is to ensure that a fortuitous difference due to a variation in the size of the image following OCRing is taken into account in the comparison.

To this end, an image A0 can be created by placing the image A in a white frame one pixel thick (the image A0 has its widths and heights increased by 2 pixels compared to those of A), and an image B0 can be created by placing the image B in a white frame one pixel thick (the image B0 has its widths and heights increased by 2 pixels compared to those of B). Then, the image A0 can be modified by blackening the 8 pixels surrounding any black pixel of the image. The image A0 becomes An and the image B0 can be modified by blackening the 8 pixels surrounding any black pixel of the image. The image B0 becomes Bn.

The principle of the verification may consist of comparing the image A in its two representations A0 and An to the image B in its two representations B0 and Bn, by superimposing the image B above the image A with a possible shift of 1 pixel along a first dimension x and/or along a second dimension y, and by finding whether there is a positioning in which:
no black pixel of B0 is superimposed on a white pixel of An,
no black pixel of A0 is superimposed on a white pixel of Bn.

The effect could be the same as the effect of verifying whether there is at least one positioning of B relative to A where the outer and inner contours of the images A and B do not differ by more than 1 pixel from each other. If this is not the case, the output of the algorithm may be that the two images A and B are not in strong coincidence, in other words that the images A and B are not substantially similar.

The strong coincidence relation can be an equivalence relation in the mathematical sense of the term, in other words if A coincides with B, then B coincides with A (symmetry) and if A coincides with B and if B coincides with C then A coincides with C (transitivity).

Based on this strong coincidence algorithm, the digit images can thus be grouped into similarity classes.

Advantageously, based on the strong coincidence algorithm, two digit images belonging to the same similarity class necessarily correspond to the same digit, even if we do not yet know which one.

Advantageously, the strong coincidence algorithm makes it possible to guarantee that the images whose pixel compositions are recognized as similar (and therefore that the images are in strong coincidence) cannot represent two different digits.

Advantageously, thanks to the strong coincidence algorithm, the method described can meet obligations of the financial sector, in particular an obligation to guarantee the accuracy of the provided financial amounts and guarantee the confidentiality of the financial data of the companies, for example against any possibility of data leakage by human operators.

Advantageously, the method can be limited to the recognition of each similarity class found through an internal OCR of the kernel computer applied to one of the images representative of the class, instead of having to recognize for example 3000 or 4000 digits contained in a document.

Advantageously, the strong coincidence algorithm can make it possible to limit verification by a human operator of the accuracy of recognitions on a reduced number of “templates” (a digit template is the association of the image of a class and its digit recognized by an internal OCR). The human verification time can be divided by a factor of at least 100, for example, and the intervention of the verification/correction operators is limited to around fifty templates to be verified. At this level of reduction, the improvement is no longer quantitative but qualitative.

The strong coincidence algorithm can also be used to resolve special cases such as the accidental presence of an isolated white pixel that needs to be eliminated or a thin black line that breaks in the middle on a digitized image that needs to be repaired. The isolated white pixel is blackened on the image An by extending one of the black pixels that touch it; the broken line can be repaired by the strong coincidence algorithm when the break is 1 or 2 pixels (the two black pixels that face each other will blacken these two white pixels that each touch one of these black pixels. Breaks not exceeding 2 pixels are thus repaired.)

If the strong coincidence algorithm does not detect the similarity of two similar digit images, one more template will have to be verified by a human operator. In any case, the number of templates to be verified by the human operator remains reduced compared to the thousands of digits that would otherwise have to be verified one by one.

When the method is applied to Referenced Tabular Documents falling under a Tabular Document Template:
a) a set of identifiers is associated with this Tabular Document Template for each box that can be filled in with numerical values of amounts to be extracted, these identifiers being able to be defined semi-arbitrarily by the application manager, drawing inspiration from those possibly appearing on the Tabular Document Template, for the table lines for example,
b) a version of the Tabular Document Template is created, called the Augmented Template, where each relevant box is filled in with the Identifier assigned to it,
c) the method then consists of transferring the corresponding Identifiers of the Augmented Template to the blanked boxes of the disfigured Referenced Tabular Document, either automatically by the kernel if its Artificial Intelligence algorithms allow it to recognize the relevant identifiers by the structural and textual environment of the boxes, or by transfer action from the Augmented Template performed by the human intelligence of the trustee, the final results being generated by the kernel in the form of a list of <identifier, value> pairs.
   an intelligent interface is used allowing the trustees to transfer the identifiers of the Augmented Template to the disfigured Referenced Tabular Document in order to fill/correct any omissions and errors in the kernel, in which an “operator” station is used consisting of two adjoining screens controlled by the same mouse passing from one to the other, allowing “Pick and Drop” operations of the Identifiers of the Augmented Template to the disfigured Referenced Tabular Document;
   Optimized action means are given to the trustees according to the following specifications:
a) transfer of an identifier from a box of the Augmented Template by clicking on this box, then on the location of the disfigured Referenced Tabular Document where it must be deposited,
b) transfer of a rectangular block of boxes from the Augmented Template to the disfigured Referenced Tabular Document, by clicking on the upper left corner, then on the lower right corner of the rectangle to be transferred, then by clicking on the upper left corner of the disfigured Referenced Tabular Document where the trustee wishes to place the identifiers of the rectangular block, the interface driver filling the transfer by updating the boxes appearing on the disfigured Referenced Tabular Document outside the transferred rectangle, likely to be filled in by a remainder of identifiers otherwise transferred by deleting them, in order to respect the rule of non-ubiquity of the Identifiers;
   said kernel (27) archives, under an index linked to the Referenced Tabular Document (for example, Siren of the Company and year, or registration number and date of a pay slip) a Revealing File containing two files:
a) the file of the disfigured Referenced Tabular Document filled in with the identifiers as stated in the steps described above,
b) the file of digit Templates labeled and verified by a trustee as stated above, these two files can be archived without violating the obligation of confidentiality of the amounts since they cannot allow them to be reconstituted on their own;
   when the kernel detects, through its indexing, that a Referenced Tabular Document has already been processed during a previous pass, it reactivates the results obtained during this first pass as archived in its Revealing File and Analyses the results as it did during this first pass;
   said Revealing File of the filled in and archived Referenced Tabular Documents can be read to make selections of filled in Referenced Tabular Documents through conditional expressions expressed in algebraic terms designating the positions involved through their Augmented Template identifiers and by browsing the original filled in Referenced Tabular Documents archived in a highly protected database, the ephemeral combination of the Revealing File and the unaltered Referenced Tabular Document making it possible to regenerate the numerical amounts and to verify whether the conditional expressions are satisfied, then delete the regenerated amounts, making a malicious intrusion unlikely in this very short period of time;
   the disclosure also provides the ability for trustees to verify whether arithmetic relationships are satisfied between certain boxes of the Referenced Tabular Documents, without seeing the amounts filled in in these boxes, by means of a Virtual Calculator that allows the kernel to verify, through the underlying amounts, whether the arithmetic relationships are satisfied and to inform the trustees of the result.

The present disclosure also relates to a system for implementing the method in accordance with the above, comprising:
a) at least one secure kernel (27) equipped with means allowing in particular disfiguring said filled in Referenced Tabular Document, extracting from filled in boxes the digit images making up the digital amounts, producing elementary images (51) of said data, OCRing said data, storing these elementary images and these OCRed data,
b) at least one driving interface (31) communicating with said secure kernel equipped with means for providing the identifiers on the screen, comparing said OCRed data (53) with said elementary images (51), making the necessary corrections, and returning said identifiers and said corrections (55) to said secure kernel (27).

The present disclosure also relates to a computer program including instructions for implementing the method in accordance with the foregoing when the program is executed by a processor.

### BRIEF DESCRIPTION OF THE DRAWINGS

Other features and advantages of the disclosure will become apparent upon reading the following description, with reference to the appended figures, which illustrate:

FIG. 1: in flowchart form the main steps of the method according to the disclosure;

FIG. 2: an example of a tabular document Template, of the CERFA type;

FIG. 3: a filled in Referenced Tabular Document, which is a filled in modified version of the form of FIG. 2;

FIG. 4: a disfigured version of the Referenced Tabular Document of FIG. 3;

FIG. 5: an identified version of the Referenced Tabular Document of FIG. 4;

FIG. 6: An augmented version of the Tabular Document Template of FIG. 2;

FIG. 7: A version pre-identified by the Referenced Tabular Document kernel of FIG. 4;

FIG. 8: An example of lines of imaged and OCRed digits to be compared; and

FIG. 9: An example of a Virtual Calculator that can be implemented within the scope of the disclosure,

### DETAILED DESCRIPTION OF THE DRAWINGS

For greater clarity, identical or similar elements are identified by identical or similar reference signs throughout the figures.

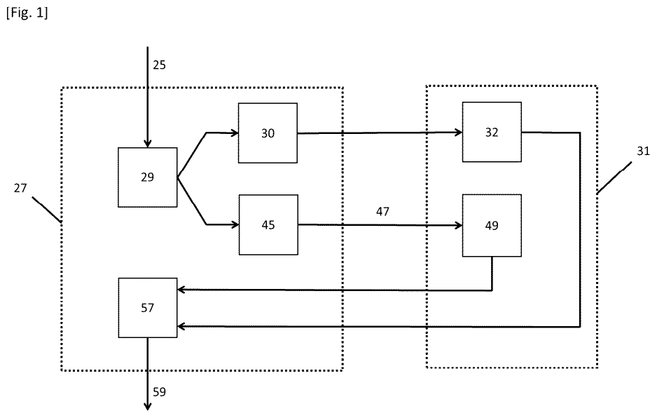

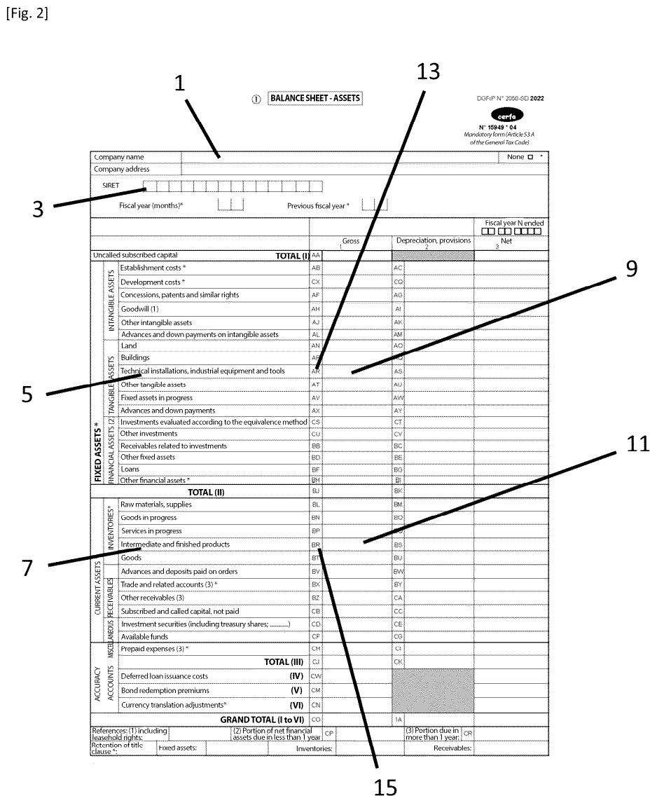

The reference numerals indicated in parentheses refer to the flowchart of FIG. 1, and the reference numerals not in parentheses refer to FIGS. 2 to 8.

For greater clarity, it is also important to precisely define the following terms used in the description and claims of the present disclosure:
OCRing: conversion of an image of a digit, letter, string of digits or letters into ASCII-type coded characters;
OCRed digit, letter, document: number, letter, document resulting from the OCRing;
Tabular Document Template: Reference document for a Referenced Tabular Document in physical (paper) or digital (file) form, such as a CERFA form from the Administration, showing the Reference tables and their cellular structures empty of any values, indicating the cellular structure that the Referenced Tabular Document must follow in order to be filled in by the kernel and/or human data entry operators;
Referenced Tabular Document: form inspired by the Tabular Document Template, but which may contain variants, such as added text, additional rows or columns, and lexicographic, synonymous, and/or abbreviated versions of the left-hand alphanumeric headings, edited and filled in by the Companies through their selected management databases;
box: materialization, often in the form of a rectangle, of the field to be filled in on the Tabular Document Template or on the Referenced Tabular Document;
identifier: code, in the form of several letters or digits associated with a box, and providing information on the nature of the information contained in the box;
Augmented Template: Tabular document template whose boxes have been filled in with corresponding identifiers, setting the selection made for these identifiers for the considered Template;
Completed Referenced Tabular Document: Referenced Tabular Document whose boxes have been filled in with amounts by the company's management software and are therefore readable by any human being;
amount: monetary or salary value (digit) provided in a box of the filled in Referenced Tabular Document;
digit: each of the digits making up the amount;
trustee: a human being responsible for verifying the accuracy of the amounts extracted from the filled in Referenced Tabular Document, and the correct assignment of identifiers to these amounts;
kernel: secure software and/or hardware space, that is to say to which, in particular, the trustees do not have access;
underlying: not accessible to the trustee, but stored in the kernel in the same location as the filled in Referenced Tabular Document;
Disfigured Referenced Tabular Document: a Referenced Tabular Document whose boxes have been stripped of their amounts by the kernel, these being stored in an underlying manner in a structured file associated with this disfigured Referenced Tabular Document and not visible to a trustee;
Identified Referenced Tabular Document: Referenced Tabular Document containing identifiers added by a trustee and/or by the kernel;
driving interface: Software and/or hardware package, managing the interactions of the trustee with the data verification screen and the feedback to the kernel according to the disclosure;
End client: The client for whom the verified data using the method according to the disclosure is intended;
Result file: File containing the verified structured data of the type <identifier/amount> pairs, usable by the end client.

We now refer to FIG. 2, which shows an example of a CERFA-type tabular document template for a company's balance sheet declaration, provided by the tax authorities.

In this illustrative and non-limiting example, the tabular document template is a form for declaring a company's balance sheet.

Of course, this tabular document template could concern any other subject, and constitute, for example, a payroll template.

By therefore referring to this tabular document template provided as example, we can see that it comprises zones 1, 3 . . . of identifying the company and the accounting exercise, as well as a certain number of textual labels 5, 7 . . . relating to the case in the asset of the considered company.

This tabular document template moreover comprises boxes 9, 11 arranged opposite the text labels 5, 7 . . . , organized in the form of rows and columns, and intended to be filled in by the company's accounting departments.

At least some of these boxes are identified by codes with several letters or digits 13, 15 . . . , the meaning of which is indicated by the text label associated with these boxes, and making it possible to identify the nature of the amount filled in the concerned box.

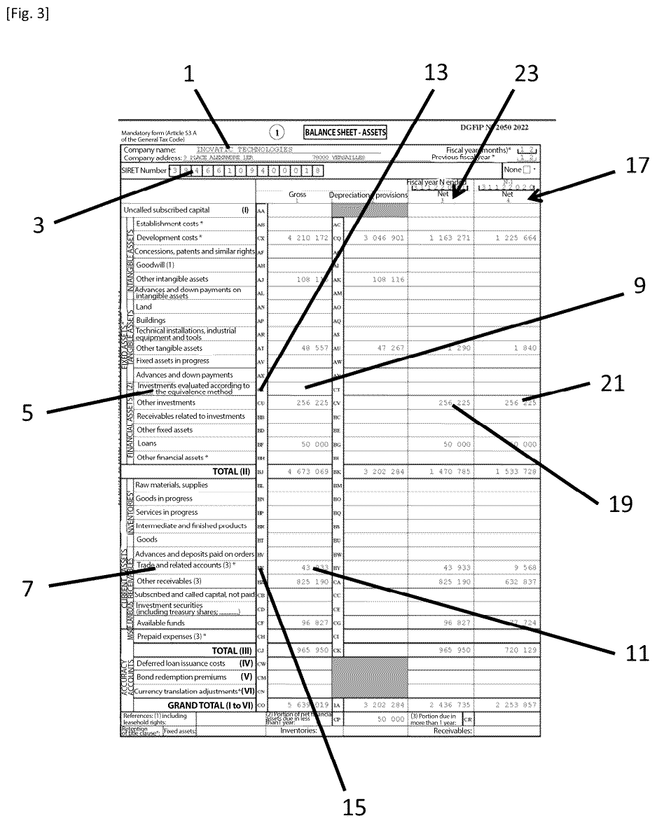

FIG. 3 shows a modified version of this Tabular document template: this modified version of the basic Tabular document template, referred to as the Referenced Tabular Document and provided to the company's accounting firm by the Accounting Document Publishers, differs essentially from the Tabular document template in FIG. 2 in that it comprises an additional column 17 allowing to display the amounts relating to year N−1.

In the specific case of FIG. 3, the Referenced Tabular Document has been filled in with the amounts 19 . . . , 21 . . . relating respectively to the financial years 2022 (column 3-reference 23) and 2021 (column 4-reference 17).

The problem is therefore as follows: the filled in Referenced Tabular Document in FIG. 3 will be subject to automatic data extraction, for example using an OCR tool, and the trustee would be responsible for verifying the accuracy of the amounts in the OCRed filled in Referenced Tabular Document, and their correct correspondence with the identifiers-without this trustee having access to these amounts at any time, in order to comply with the confidentiality obligations described above.

To do this, an image file of the filled in Referenced Tabular Document is generated. This allows to OCR the image file later.

The image file of the filled in Referenced Tabular Document is then sent (25) to the kernel (27) of the system according to the disclosure without the trustee having access to it.

The image file of the filled in Referenced Tabular Document is then OCRed (29), and all the amounts filled in the boxes of the image file of the filled in Referenced Tabular Document are removed (30), and stored in memory in the kernel (27): they therefore become underlying.

The first task of the trustee will be to verify that the identifiers 13, 15 . . . are located in the correct place, that is to say each one next to a box 9, 11, . . . whose textual label 5, 7 . . . corresponds to this identifier.

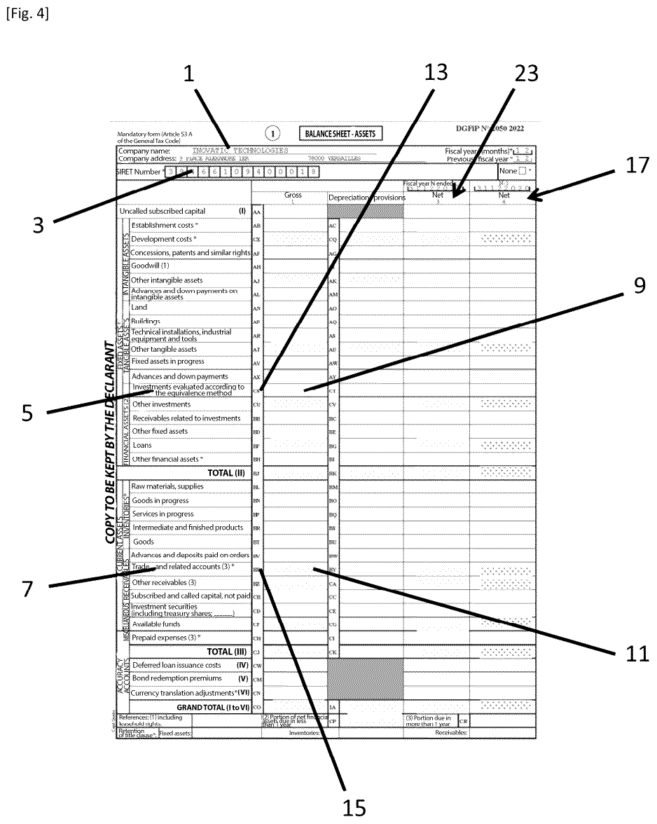

According to a first variant, the kernel (27) returns to the driving interface (31) of the trustee the disfigured Referenced Tabular Document visible in FIG. 4, that is to say the Referenced Tabular Document with empty boxes and others filled in by the kernel.

The task of the trustee is to fill in (32) the correct identifiers within the relevant boxes: this filling can confirm the identifier that is part of the disfigured Referenced Tabular Document filled in by the kernel (in which case, it leaves things as is), or correct it if there is an error.

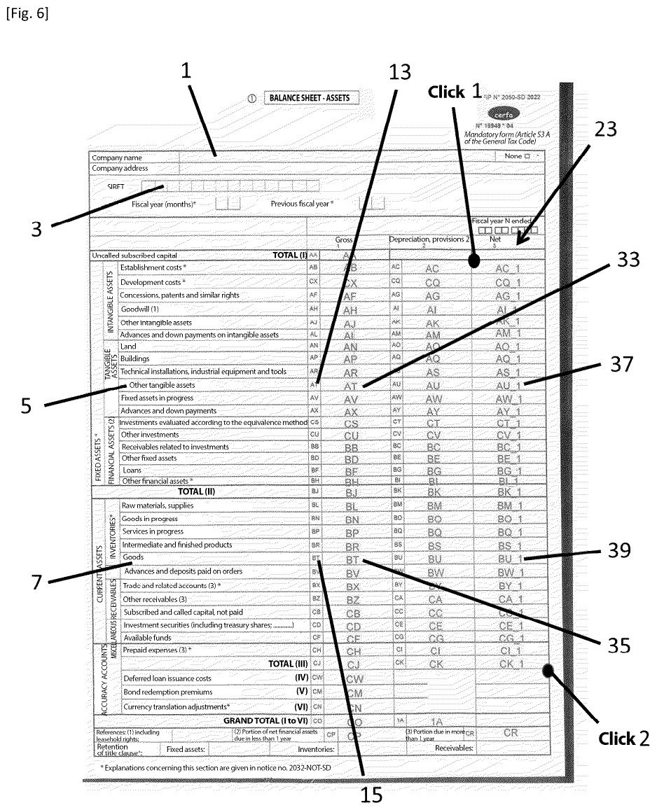

To assist in this verification task, the trustee can use the Augmented Template in FIG. 6: the boxes of this template have been filled in once and for all with identifiers that allow the unique identification of the nature of these boxes (additional identifiers of the AC_1 type are created for boxes that lack official identifiers, as is the case for the boxes in the 3^{rd} column of the Tabular document template in FIG. 6).

The trustee can then perform «click and drop» operations on boxes or groups of boxes in the Tabular document template to place them in the appropriate areas of the disfigured Referenced Tabular Document.

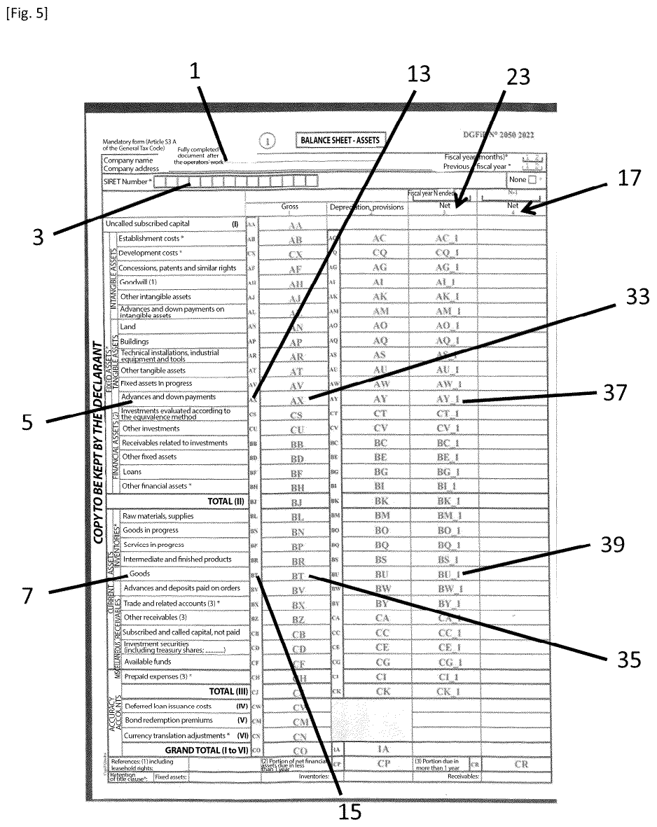

Following this intervention by the trustee, the Referenced Tabular Document identified in FIG. 5 is obtained, the relevant boxes of which have been filled in with the identifiers 33, 35 . . . selected by the trustee.

Note, as seen in FIG. 5, that the trustee left the last column 17 blank: this column 17, relating to the fiscal year N−1, was in fact added to the Referenced Tabular Document in relation to the Tabular document template and is not part of the requested data. This example assumes that the kernel found nothing in the preliminary run.

It is therefore important to ignore the amounts appearing in this additional column, which will be done automatically by the kernel when editing the results since none of these boxes are filled in with an identifier.

If necessary, the modifications to the identifiers made by the trustee are returned to the kernel (27), which is updated, ensuring perfect consistency with the image on the screen.

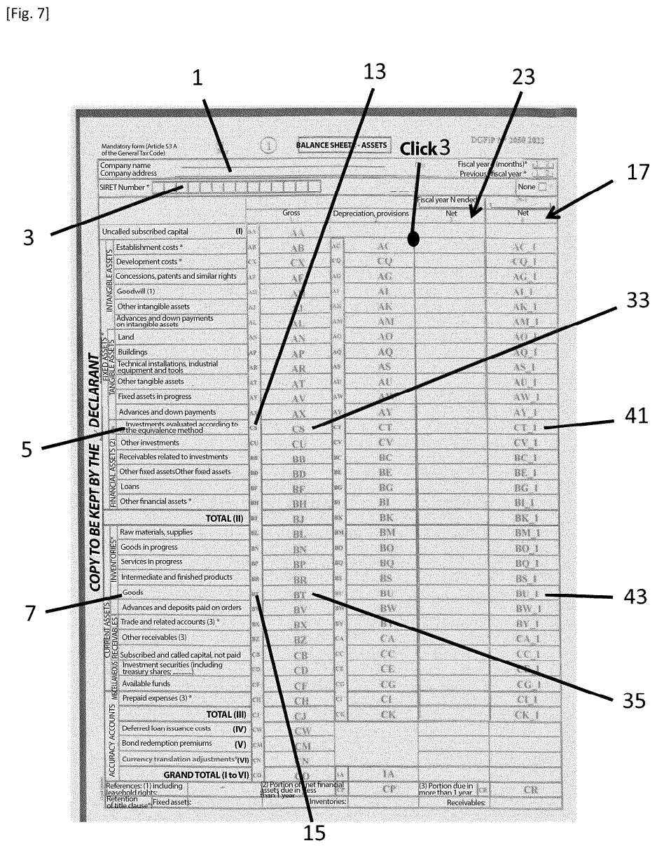

According to another possible variant, the identifiers 33, 35 . . . can be at least partially pre-filled in by the kernel (27) in the boxes of the disfigured Referenced Tabular Document: for example, this Referenced Tabular Document thus pre-filled in can appear on the driving interface (31) of the trustee in the form visible in FIG. 7.

The work of the trustee will then consist of verifying that the identifiers pre-filled in by the kernel (27) in the boxes are correct.

In the example shown in FIG. 7, we can also see that identifiers 41, 43 . . . were placed by the kernel in the last column 17 of the pre-filled in Referenced Tabular Document, relating to the financial year N-1, whereas they should have been placed in the penultimate column, relating to the financial year N.

An additional task for the trustee will therefore consist of selecting the last column on the Augmented Template in FIG. 6 by clicking on its top left corner (click 1) then on its bottom right corner (click 2) and then clicking, on the Referenced Tabular Document in FIG. 7, on the top left corner of the 3^{rd} column (click 3), this last click causing the interface driver to transfer the 3^{rd} column of the Augmented Template in FIG. 6 to the 3^{rd} column of the Referenced Tabular Document in FIG. 7.

The interface driver will then have to correct the identifiers transferred elsewhere from the Augmented Template, which therefore remain in the 4^{th} column and must therefore be deleted, applying the identifier non-ubiquity rule.

More generally, during such an identifier transfer from the Augmented Template to the Referenced Tabular Template, the interface driver will have to ensure that the repositioned identifiers do not remain visible in their position before the transfer.

Indeed, the copy of the 3^{rd} transferred column will automatically delete any identifiers that appeared in this column, but a remainder of these same identifiers could remain elsewhere, for example, in the 4^{th} column. In this case, the identifiers that were incorrect in the 4^{th} column remain in place and must be deleted by the driver.

Another example: two consecutive lines are reversed; in this case, for example, we will take the lower line from the Augmented Template and place it on the upper line; the lower line will then be erased. We will then have to take the upper line from the Augmented Template and transfer it to the lower line.

The second verification task performed by a trustee will consist of ensuring recognition of the amounts in the sensitive boxes of the filled in Referenced Tabular Document, to which only the kernel (25) has access, the trustee must perform this task without ever seeing them. Two methods are successively proposed: the first is Basic, the second is Optimal.

Basic Method: Recognition of Digits in anonymously dispersed Spare Parts. To perform this verification, the kernel (27) retrieves the images of each digit making up each amount located in each box of the filled in Referenced Tabular Document, and associates (45) with each of these images the corresponding digit obtained by OCRing the filled in Referenced Tabular Document.

All of the <digit image/OCRed value> pairs are then grouped in ascending order of recognized values and sent (47) to the driving interface (31), where the trustee can verify (49) whether the conversion of the digit image into an OCRed digit was performed without error and, if not, correct the erroneous value on screen. In doing so, they cannot deduce any information about the original position of these digits in a given box, thus preserving the required Confidentiality.

Optimal Method: The grouping into Digit patterns. Advantageously, to limit the number of verifications to be performed, digit images can be grouped into shape proximity classes, with all images in the same class being distinguished from each other by very small differences, for example, a difference in a few isolated pixels. By «a few isolated pixels> is meant, for example, at least two pixels, for example, 2 pixels, 3 pixels, or 4 pixels.

The grouping into digit patterns (or similarity classes) can be done based on the strong coincidence algorithm described above.

The data extraction method using the strong coincidence algorithm may therefore comprise a step of comparing the digit images with each other, possibly based on the pixel composition of said digit images in order to identify similarities in the pixel compositions of the digit images, as well as a step of dividing the digit images into similarity classes based on a result of the comparison of their pixel composition, such that two images whose pixel compositions are substantially identical are comprised in the same similarity class.

Advantageously, this makes it possible to identify substantially similar digit images in a simple manner in order to group images corresponding to the same digit into the same similarity class.

However, due to the OCRing, a generated digit image may have accidental pixel differences relative to another similar digit image. To overcome this problem, the extraction method may comprise a step of modifying at least one parameter of a digit image before comparing said digit image with another digit image. The at least one parameter may be a dimension of the digit image. Advantageously, this makes the comparison between the digit images more precise. Advantageously, this ensures that a digit image is correctly classified in the class in which it should be classified, despite a difference in its pixel composition that would be due to a random variation in the size of the digit image.

The inventor of this Method has developed a proprietary algorithm called «strong coincidence»: two images that strongly coincide are placed in the same class, and the property of the strong coincidence relationship is that it is an equivalence relationship in the mathematical sense of the term: two images linked by the strong coincidence relationship always correspond to the same digit, even if the value of that digit is not yet known. Each class then falls under the mathematical concept of Template, and each Template is then OCRed on any image representing it.

By grouping these images into Digit Templates, the number of verifications of the <digit image/OCRed digit> pairs to be performed by the trustee can thus be substantially reduced: typically, verifications go from several thousand pairs to only a few dozen. At this level, the quantitative gain can be considered qualitative.

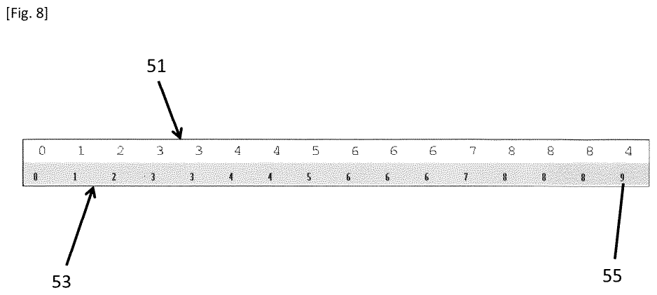

For illustration purposes, FIG. 8 shows two rows of digits representing the digit templates defined by the strong Coincidence algorithm to be verified by the trustee: the upper row 51 reproduces the digit image templates, through their representatives, and the lower row 53 comprises the digits obtained by OCR processing each of the images in the upper row: the trustee's work therefore consists of visually verifying that the digits in the lower row correspond to the images in the upper row.

If a digit in the lower row 53 does not match the image of the digit in the upper row 51, as seen at 55 in FIG. 8 (digit 9 in the lower row and image of a 4 in the upper row), the trustee corrects the digit in the lower row with a 4 on their driving interface.

This correction is transmitted to the kernel (27), which will then update the values associated with the corrected digit templates.

The amounts in each box can then be reconstructed automatically and without error by the kernel by extracting the actual images of the digits in the box, successively «recognizing» them by comparing them with the images of each digit template using the strong Coincidence algorithm, retaining the numerical value associated with the matching digit template.

The trustee has then filled in their task, ensuring the error-free extraction of the values from the sensitive boxes without ever having access to these amounts or being able to reconstitute them in any way.

Once the two verification steps described above have been filled in, the kernel (27) scans all the boxes of the Referenced Tabular Document in which the verified identifiers have been filled in, and associates (57) with each of these identifiers the underlying amounts reconstituted by the kernel (27) as mentioned above.

This produces a series of verified <identifier/amount> pairs, which can be structured within a verified results file (59), edited in the format requested by the end client, that is to say that of the Financial Analysis Software that he uses, and which generally does not depend on him, but on the Financial Analysis professional publisher/designer of this software. As such, this Publisher can choose two formats for inputting results:
an <identifier/amount> type mode, with identifiers specific to the Publisher, and in this case, the Service Provider must have a dictionary translating its own identifiers into those requested by the Financial Analysis software,
a «Mapping» mode giving the order in which the requested numeric results appear in a single-value file, the translation being able to be carried out using a grid indicating the list of the Service Provider's identifiers corresponding to each position in the Financial Analysis software Publisher.

It is therefore understood that the disclosure makes it possible to verify the reliability of the <identifier/amount> pairs without ever accessing information enabling these amounts to be reconstituted: the driving interface (31) makes it possible to carry out this verification indirectly, by reading and comparing isolated figures whose origin the trustee cannot identify.

Following the two verification steps described above, the kernel (27) retains in the service provider's database, and for the processed Referenced Tabular Document, a Revealing File associated with this Document, consisting of:
a file of the physical location of the identifiers in the boxes of the Referenced Tabular Document,
and the file of the Digit Templates verified by the trustee,
this Revealing File being uniquely indexed by any appropriate means such as the combination of a company registration number (SIREN/SIRET) with the date of publication of the verified results file, or, more anonymously, by a chronological number for which the kernel (27) has the processing key.

This Revealing File does not contain any of the amounts listed in the boxes of the filled in form, which reinforces the request for data confidentiality since none of these amounts are archived.

When the Service Provider receives a new document to process, it checks its database to see if a previous passage of the same document has been recorded, which the kernel (27) detects through the indexing of the already archived Revealing Files. This allows the aforementioned Revealing File to be immediately loaded into the memory of the kernel (27), and thus, by exhuming it, to find the results transmitted at the time by the operators and to reissue the final results identically to what it had done at the time in fille confidentiality, this:
without the amounts located in the boxes of the filled in Referenced Tabular Document having been stored anywhere in the system, and
without requiring any new verification operation from the trustee.

By way of illustration, if, between the initial and subsequent passes of the Referenced Tabular Document filled in the system according to the disclosure, certain amounts had been modified, the newly generated Results file would take this change into account.

Naturally, the disclosure is described above using examples. It is understood that a person skilled in the art is able to implement various variants of the disclosure without departing from the scope of the disclosure.

Thus, for example, the disclosure could be applied to the verification of data other than <identifier/amount> pairs: this could involve the verification of triplets, quadruplets, n-uplets of encrypted or lettered data, or even graphic elements.

This also allows the kernel to ignore alphanumeric characters other than the 10 digits in upright/italic/normal/bold type, and in particular upper/lower case letters and special characters in upright/italic/normal/bold type, thus reducing the number of characters to be verified from at least 400 to 40.

This also allows human intervention to be replaced for the second step described above, of verifying the digits associated with each digit template, by sending images of these digit templates, ordered in ascending order of the values found for these digits by the internal OCR, to a specialized external service provider with very powerful OCR capabilities, such as GOOGLE®, replacing the human operator verifying these values with fille automation.

It is also possible to provide for the kernel (27) to perform additional verifications by performing operations on the amounts underlying the identifiers provided in the filled in Referenced Tabular Document.

These operations may be, for example, of the type XX1_2+XX2_2+XX3_2+ . . . XXn_2=TOT_2 (example for column _2, where XXi_2 denotes the identifier of row i), or YY2_1−YY22=YY2_3 (example for row 2, where YY2_i denotes the identifier of column i).

This is also how we could plan to use the Revealing Files stored in the kernel to perform Company Selections according to certain criteria expressed in the form of conditional algebraic expressions using the Identifiers of the involved positions, and a highly protected archive containing the history of the initial processed Referenced Tabular Documents, allowing the amounts in the boxes to be surreptitiously regenerated as indicated in [0095] for a second pass, while the regenerated data is used for the programmed selection.

Example: company search whose turnover (identifier XX) is comprised between such and such amount: the time span during which the amounts regenerated for each processed Referenced Tabular Document could be hacked from the outside is reduced to a few milliseconds, making this risk unlikely.

This is also how the security level of the disclosure could be further increased by providing for the temporary connection, in another secure kernel, of the filled in Referenced Tabular Document and the associated Revealing File, only during the very short time during which the Revealing File is queried to perform a specific search, such as a search by turnover.

This is also how peripheral tools can be added to the method of the disclosure, based on the same general principle of masking data from trustees.

An example of such a tool, which proves very practical in use, is a Virtual Calculator (which could also be called a Disfigured Calculator), allowing trustees to verify whether arithmetic relationships between certain boxes of the Referenced Tabular Documents are satisfied, without seeing the amounts filled in these boxes.

The Virtual Calculator fits in a line placed at the bottom of the page of the Referenced Tabular Document verification screen, like a footnote, and remains fixed, the display screen reserved for the processed Referenced Tabular Document being limited to the full-page frame, which is refreshed each time the document is moved to the next page, and can also have a vertical shuttle if necessary.

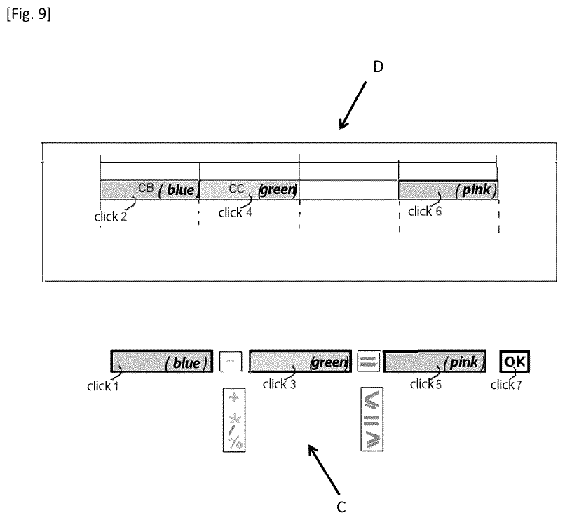

The Virtual Calculator consists of three rectangular boxes that follow one another along the line, interspersed with two multiple-selection symbols: arithmetic signs and amount relationship signs. A square box containing the symbol «OK» ends the line. The three rectangular boxes are filled in with a background color specific to each box: for example, blue for the first, green for the second, pink for the third, as shown in FIG. 9.

The principle of the Virtual Calculator is that the trustee indicates the boxes on the displayed page of the Referenced Tabular Document whose amount must be transferred into each of the colored boxes. The differentiated coloring of the boxes serves to display on the Document the box selected to transfer its value: it is colored by the color of the receiving box. Indeed, the boxes in the Referenced Tabular Document are not necessarily filled in with an identifier; quite the contrary, otherwise, there would be no need to resolve the ambiguity.

Once the trustee has designated the boxes corresponding to each color and selected the arithmetic signs and those relating to the relationships between amounts, they click on the square «OK» box, which sends the location of the colored boxes of the Referenced Tabular Document, and selected arithmetic and relationship signs, to the kernel. The kernel that:
extracts the amounts underlying the colored boxes,
performs the requested arithmetic calculations,
verifies the numerical relationship between amounts, with a tolerance of two monetary units (€ for example),
returns its result to the interface driver,
upon receipt, the interface driver fills in the OK box:
in green if the result is positive,
in red if it is negative.

The trustee then simply makes their selections based on the result and continues their verification.

EMBODIMENT: Referring to FIG. 9, reference D designates the Referenced Tabular Document, and C the Virtual Calculator.

Initially, the three boxes of the Virtual Calculator are blank.

Then:
Click 1: the box is filled in with blue;
Click 2: the box clicked on the Document is filled in with blue;
Click 3: the box is filled in with green;
Click 4: the box clicked on the Document is filled in with green;
Click 5: the box is filled in with pink;
Click 6: the box clicked on the Document is filled in with pink;
Click 7: selection of the arithmetic operator;
Click 8: selection of the logical relationship;
Click 9: the «OK» box is filled in with green: sending the request to the kernel.

Returning results from the kernel to the Interface Driver:
If OK, the «OK» box is filled in with yellow;
If not OK, the «OK» box is filled in with red.

1. A method for semi-automatic extracting data located in a referenced tabular document, whether paper or digital, comprising boxes, identifiers of these boxes, and amounts filled in these boxes, the method includes the following steps:
a) sending the image file of the filled in referenced tabular document in a secure kernel computer without a trustee being able to access it,
c) removing by means of this kernel computer all the amounts filled in the boxes of the referenced tabular document, leading to a disfigured referenced tabular document,
e) providing the correct identifiers inside the concerned boxes, emptied of their amounts,
f) causing the kernel computer to extract the images of each digit making up each of said amounts,
g) associating by means of the kernel computer the corresponding digit obtained by OCRing the filled in referenced tabular document with each of said images,
h) causing a trustee to verify on a driving interface whether the conversion of the image of the digit into an OCRed digit has been performed without error, by reading and comparing isolated digits whose origin the trustee cannot identify,
i) if this is not the case, causing the trustee to correct the erroneous value on the driving interface,
j) updating by the kernel computer the values associated with said images,
k) causing the kernel computer to browse through all the boxes of the referenced tabular document in which the verified identifiers were filled in in step e), and causing the kernel computer to associate the underlying amounts reconstituted by this kernel computer with each of these identifiers.

2. The method according to claim 1 further comprising the following step:
b) OCRing in this kernel computer this referenced tabular document.

3. The method according to claim 1, further comprising the following step:
d) storing these amounts in memory in the kernel computer, such that they become underlying, that is to say not accessible to the trustee.

4. The method according to claim 1, comprising a step of generating the image file of the filled in referenced tabular document.

5. The method according to claim 1, comprising a step of comparing the digit images with each other.

6. The method according to claim 5, wherein the step of comparing the digit images is done based on the pixel composition of said digit images in order to identify similarities in the pixel compositions of the digit images.

7. The method according to claim 6, comprising a step of distributing the digit images into similarity classes based on a result of the comparison of their pixel composition, such that two images whose pixel compositions are substantially identical are comprised in the same similarity class.

8. The method according to claim 5, comprising a step of modifying at least one parameter of a digit image before comparing said digit image with another digit image.

9. The method according to claim 8, wherein the at least one parameter is a dimension of the digit image.

10. The method according to claim 1, wherein said digit images are grouped by shape proximity classes, and wherein the shape proximity classes are determined by grouping images that differ from each other only by a few isolated pixels.

11. The method according to claim 1, wherein the correct identifiers are filled in in step e) by a trustee.

12. The method according to claim 1, wherein the correct identifiers are pre-filled in at least in part in step e) by the kernel computer, and a trustee verifies that the identifiers pre-filled in by the kernel computer are correct.

13. The method according to claim 1, wherein step e) is carried out by transferring to the empty boxes of the disfigured referenced tabular document corresponding identifiers provided in the boxes of a augmented tabular document template and freezing the choices decided for these identifiers for the considered template.

14. The method according to claim 1, wherein a revealing file associated with the referenced tabular document is stored in the kernel computer in accordance with any one of the preceding claims, this revealing file comprising a file of physical location of the identifiers in said referenced tabular document and a file of the digits verified by the trustee, this revealing file not containing any of the amounts appearing in the boxes of the filled in referenced tabular document, and when the referenced tabular document is passed, this passage is detected by the kernel computer and the revealing file is loaded into the memory of the kernel computer, making it possible to regenerate identically the results verified by the trustee.

15. A computer program including instructions for implementing the method according to claim 1 when the program is executed by a processor.
